(19) United States
(12) Patent Application Publication
(10) Pub. No.: US 2023/0290046 A1
(43) Pub. Date: Sep. 14, 2023

(54) MULTIVIEW DISPLAY SYSTEM AND METHOD EMPLOYING MULTIVIEW IMAGE CONVERGENCE PLANE TILT

(71) Applicant: LEIA INC., Menlo Park, CA (US)

(72) Inventors: Nicolas Dahlquist, Redwood City, CA (US); Jesse Ozog, Menlo Park, CA (US)

(21) Appl. No.: 18/197,078

(22) Filed: May 14, 2023

Related U.S. Application Data
(63) Continuation of application No. PCT/US2020/066251, filed on Dec. 18, 2020.
(60) Provisional application No. 63/115,531, filed on Nov. 18, 2020.

(51) Int. Cl. G06T 15/20; G06T 1/20; G06T 7/70; G06T 3/60; G09G 3/34

(52) U.S. Cl. CPC G06T 15/205; G06T 1/20; G06T 7/70; G06T 3/608; G09G 3/3426; G06T 2207/20228; G09G 2310/0297; G09G 2354/00; G06T 2200/24

(57) ABSTRACT

Systems and methods are directed to loading a view of the multiview image into memory. The view may be formatted as a bitmap defined by a pixel coordinate system. A distance between the view and a center point of view may be identified. Thereafter, the view may be rendered in a graphics pipeline as a sheared view according a shear function applied along an axis of the pixel coordinate system. A shear strength of the shear function correlates with the distance between the view and the center point of view.

### CROSS-REFERENCE TO RELATED APPLICATIONS

This application is a continuation patent application of and claims priority to International Patent Application No. PCT/US2020/066251, filed Dec. 18, 2020, which claims the benefit of priority to U.S. Provisional Application No. 63/115,531, filed on Nov. 18, 2020, the entirety of each of which are incorporated by reference herein.

### STATEMENT REGARDING FEDERALLY SPONSORED RESEARCH OR DEVELOPMENT

N/A

### BACKGROUND

A scene in three-dimensional (3D) space may be viewed from multiple perspectives depending on the viewing angle. In addition, when viewed by a user with stereoscopic vision, multiple views representing different perspectives of the scene may be perceived contemporaneously, effectively creating a sense of depth that may be perceived by the user. Multiview displays present images having multiple views to represent how scenes are perceived in the 3D world. A multiview display renders different views contemporaneously to provide a realistic experience to the user. Multiview images may be generated and processed dynamically by software. Thereafter they may be rendered by a graphics pipeline in real time. A graphics pipeline may apply a variety of operations on the multiview image when rendering the multiview image for display.

### BRIEF DESCRIPTION OF THE DRAWINGS

Various features of examples and embodiments in accordance with the principles described herein may be more readily understood with reference to the following detailed description taken in conjunction with the accompanying drawings, where like reference numerals designate like structural elements, and in which:

FIG. 1 illustrates a multiview image in an example, according to an embodiment consistent with the principles described herein.

FIG. 2 illustrates an example of generating a multiview image, according to an embodiment consistent with the principles described herein.

FIG. 3 illustrates an example of tilting the plane of convergence of a multiview image, according to an embodiment consistent with the principles described herein.

FIG. 4 illustrates an example of a computing system that tilts a plane of convergence of a multiview image according to an embodiment consistent with the principles described herein.

FIGS. 5A and 5B illustrate an example of applying a shear function, according to an embodiment consistent with the principles described herein.

FIG. 6 illustrates an example of interfacing with a graphics pipeline, according to an embodiment consistent with the principles described herein.

FIGS. 7A and 7B illustrate examples of a user interface to configure the rendering of a multiview image according to embodiments consistent with the principles described herein.

FIG. 8 illustrates an example of a computing system that applies a shear function as pixels are sampled according to an embodiment consistent with the principles described herein.

FIG. 9 illustrates a flowchart of a system and method of tilting a plane of convergence of a multiview image according to an embodiment consistent with the principles described herein.

FIG. 10 illustrates a schematic block diagram that depicts one example illustration of a multiview display system providing a multiview display according to an embodiment consistent with the principles described herein.

Certain examples and embodiments have other features that are one of in addition to and in lieu of the features illustrated in the above-referenced figures. These and other features are detailed below with reference to the above-referenced figures.

### DETAILED DESCRIPTION

Examples and embodiments in accordance with the principles described herein provide techniques to improve the users experience of perceiving multiview images by tilting the plane of convergence. As a default, the plane of convergence is typically in parallel with the camera lens at some distance away from the camera. Objects intersected by the plane of convergence appear in focus such that there is no disparity between the different views of such objects. However, when the point of view changes to an extreme angle such as, for example, a bird's-eye view angle, objects of interest in the multiview image may be subject to disparity in a manner that negatively impacts the viewing experience. As described herein, embodiments are directed to tilting the plane of convergence to improve the way objects are perceived based on the angle of the camera's view. In the case of a bird's-eye view, the plane of convergence may be tilted so that it is substantially parallel with the ground. As a result, objects closer to the ground may be perceived with more clarity from the viewer's perspective.

Embodiments are directed to applying graphics-level operations to tilt the plane of convergence in a real-time graphics pipeline. For example, the plane of convergence may be tilted as part of a post-processing operation as the multiview image is rendered in real time. A shader in a graphics pipeline may be configured to apply a shear function to different views to effectively tilt the plane of convergence. For example, the shader may sample pixels from a view of a multiview image in a manner that shears the resulting view. The amount of shearing may correspond to the degree that a particular view is distanced away from a center point of view. To this end, the shear function shears different views of a multiview in real time to effectively tilt the plane of convergence, thereby creating a better viewing experience for the viewer.

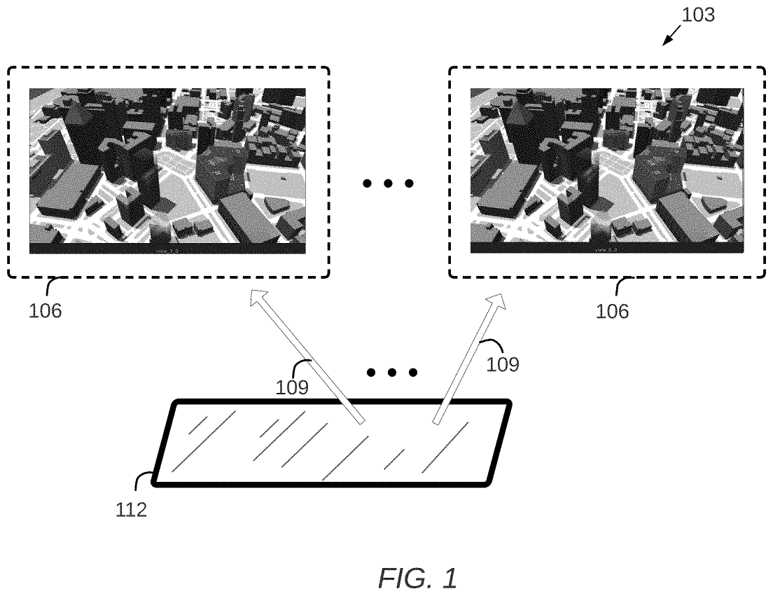

FIG. 1 illustrates a multiview image 103 in an example, according to an embodiment consistent with the principles described herein. The multiview image 103 has a plurality of views 106. Each of the views 106 corresponds to a different view direction 109. The views 106 are rendered for display by a multiview display 112. The multiview image 103 shown in FIG. 1 depicts a view of various buildings on the ground from a birds-eye perspective. Each view 106 represents a different viewing angle of the multiview image 103. The different views 106 therefore have some level of disparity with respect to one another. In some embodiments, a viewer may perceive one view 106 with her right eye while perceiving a different view 106 with her left eye. This allows a viewer to perceive different views simultaneously resulting in stereoscopic vision. In other words, the different views 106 create a three-dimensional (3D) effect.

In some embodiments, as a viewer physically changes her viewing angle with respect to the multiview display 112, the viewer's eyes may catch different views 106 of the multiview image 103. As a result, the viewer may interact with the multiview display 112 to see different views 106 of the multiview image 103. For example, as the viewer moves to the left, the viewer may see more of the left side of the buildings in the multiview image 103. The multiview image 103 may have multiple views 106 along a horizontal plane and/or have multiple views 106 along the vertical plane. Thus, as a user changes the viewing angle to see different views 106, the viewer may gain additional visual details of the multiview image 103. When processed for display, the multiview image 103 is stored as data in a format that records the different views 106.

As discussed above, each view 106 is presented by the multiview display 112 at different, corresponding view directions 109. When presenting the multiview image 103 for display, the views 106 may actually appear on or in a vicinity of the multiview display 112. A 2D display may be substantially similar to the multiview display 112, except that the 2D display is generally configured to provide a single view (e.g., only one of the views) as opposed to the different views 106 of the multiview image 103.

Herein a ‘two-dimensional display’ or ‘2D display’ is defined as a display configured to provide a view of an image that is substantially the same regardless of a direction from which the image is viewed (i.e., within a predefined viewing angle or range of the 2D display). A conventional liquid crystal display (LCD) found in many smart phones and computer monitors are examples of 2D displays. In contrast herein, a ‘multiview display’ is defined as an electronic display or display system configured to provide different views of a multiview image in or from different view directions contemporaneously from the user's perspective. In particular, the different views 106 may represent different perspective views of a multiview image 103.

The multiview display 112 may be implemented using a variety of technologies that accommodate the presentation of different image views so that they are perceived contemporaneously. One example of a multiview display is one that employs diffraction gratings to control the principle angular directions of the different views 106. According to some embodiments, the multiview display 112 may be a lightfield display, which is one that presents a plurality of light beams of different colors and different directions corresponding to different views. In some examples, the lightfield display is a so-called ‘glasses free’ three-dimensional (3-D) display that may use diffractive gratings to provide autostereoscopic representations of multiview images without the need to special eye wear to perceive depth. In some embodiments, the multiview display 112 may require glasses or other eyewear to control which views 106 are perceived by each eye of the user.

In some embodiments, the multiview display 112 is part of a multiview display system that renders multiview images and 2D images. In this respective, the multiview display system may include a plurality of backlights to operate in different modes. For example, the multiview display system may be configured to provide broad-angle emitted light during a 2D mode using a broad-angle backlight. In addition, the multiview display system may be configured to provide directional emitted light during a multiview mode using a multiview backlight having an array of multibeam elements, the directional emitted light comprising a plurality of directional light beams provided by each multibeam element of the multibeam element array. The multiview display system may be configured to time multiplex the 2D and multiview modes using a mode controller to sequentially activate the broad-angle backlight during a first sequential time interval corresponding to the 2D mode and the multiview backlight during a second sequential time interval corresponding to the multiview mode. Directions of directional light beams of the directional light beam may correspond to different view directions of a multiview image.

For example, in 2D mode, the broad-angle backlight may generate images so that the multiview display system operates like a 2D display. By definition, ‘broad-angle’ emitted light is defined as light having a cone angle that is greater than a cone angle of the view of a multiview image or multiview display. In particular, in some embodiments, the broad-angle emitted light may have a cone angle that is greater than about twenty degrees (e.g., >±20°). In other embodiments, the broad-angle emitted light cone angle may be greater than about thirty degrees (e.g., >±30°), or greater than about forty degrees (e.g., >±40°), or greater than about fifty degrees (e.g., >±50°). For example, the cone angle of the broad-angle emitted light may be greater than about sixty degrees (e.g., >±60°).

The multiview mode may use a multiview backlight instead of a broad-angle backlight. The multiview backlight may have an array of multibeam elements that scatter light as plurality of directional light beams having principal angular directions that differ from one another. For example, if the multiview display 112 operates in a multiview mode to display a multiview image having four views, the multiview backlight may scatter light into four directional light beams, each directional light beam corresponding to a different view. A mode controller may sequentially switch between 2D mode and multiview mode so that a multiview image is displayed in a first sequential time interval using the multiview backlight and a 2D image is displayed in a second sequential time interval using the broad-angle backlight.

In some embodiments, the multiview display system is configured to guide light in a light guide as guided light. Herein, a ‘light guide’ is defined as a structure that guides light within the structure using total internal reflection or ‘TIR’. In particular, the light guide may include a core that is substantially transparent at an operational wavelength of the light guide. In various examples, the term ‘light guide’ generally refers to a dielectric optical waveguide that employs total internal reflection to guide light at an interface between a dielectric material of the light guide and a material or medium that surrounds that light guide. By definition, a condition for total internal reflection is that a refractive index of the light guide is greater than a refractive index of a surrounding medium adjacent to a surface of the light guide material. In some embodiments, the light guide may include a coating in addition to or instead of the aforementioned refractive index difference to further facilitate the total internal reflection. The coating may be a reflective coating, for example. The light guide may be any of several light guides including, but not limited to, one or both of a plate or slab guide and a strip guide. The light guide may be shaped like a plate or slab. The light guide may be edge lit by a light source (e.g., light emitting device).

In some embodiments, the multiview display system is configured to scatter out a portion of the guided light as the directional emitted light using multibeam elements of the multibeam element array, each multibeam element of the multibeam element array comprising one or more of a diffraction grating, a micro-refractive element, and a micro-reflective element. In some embodiments, a diffraction grating of a multibeam element may comprise a plurality of individual sub-gratings. In some embodiments, a micro-reflective element is configured to reflectively couple or scatter out the guided light portion as the plurality of directional light beams. The micro-reflective element may have a reflective coating to control the way guided light is scattered. In some embodiments, the multibeam element comprises a micro-refractive element that is configured to couple or scatter out the guided light portion as the plurality of directional light beams by or using refraction (i.e., refractively scatter out the guided light portion).

As illustrated in FIG. 1, the multiview display 112 comprises a screen to display a multiview image 103. The screen may be a display screen of a telephone (e.g., mobile telephone, smart phone, etc.), a tablet computer, a laptop computer, a computer monitor of a desktop computer, a camera display, or an electronic display of substantially any other device, for example.

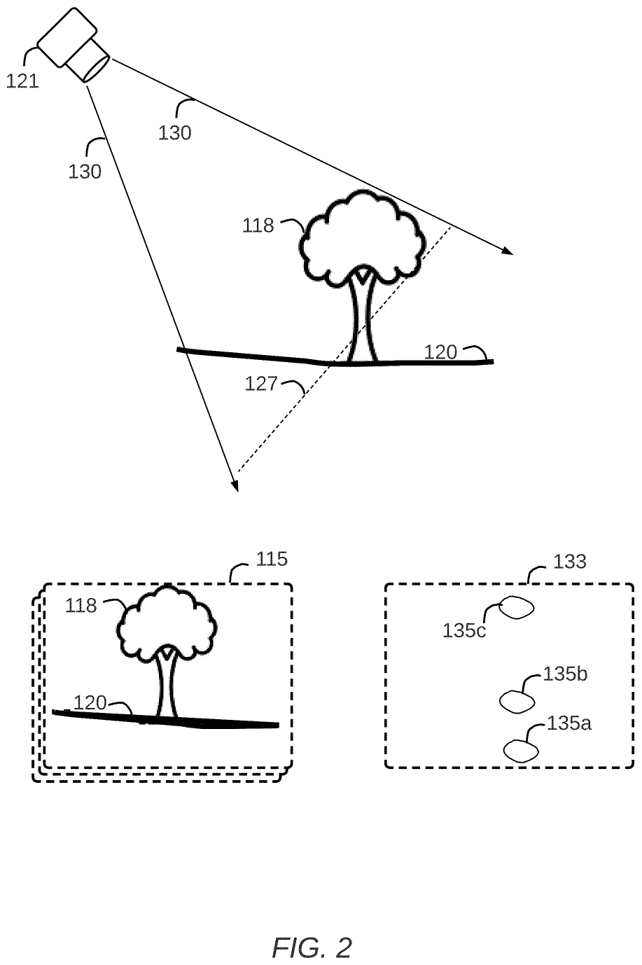

FIG. 2 illustrates an example of generating a multiview image 115, according to an embodiment consistent with the principles described herein. The multiview image 115 of FIG. 2 contains various objects such as a tree 118 on the ground 120. The tree 118 and ground 120 may be referred to as objects, which together, form at least part of a scene. The multiview image 115 may be displayed and viewed in a manner like the manner discussed with respect to FIG. 1. To generate the multiview image 115, a camera 121 may be used to capture the scene. In some embodiments, the camera 121 may include one or more physical cameras. For example, a physical camera includes a lens for capturing light and recording it as an image. Multiple physical cameras may be used to capture different views of the scene to create the multiview image 115. For example, each physical camera may be spaced apart at a defined distance to allow different perspectives of the objects in the scene to be captured. The distance between the different physical cameras allows for the ability to capture depth of the scene, the same way that the distance between a viewer's eyes allow for 3D vision.

The camera 121 may also represent a virtual (e.g., simulated or hypothetical) camera as opposed to a physical camera. The scene may be generated using computer graphics techniques that manipulate computer-generated information. In this example, the camera 121 is implemented as a virtual camera having a point of view to generate the scene using software tools for editing images. The virtual camera may be defined in terms of viewing angle and coordinates of 3D model. The 3D model may define various objects that are captured by the virtual camera.

In some embodiments, one or more views of the multiview image 115 may be generated through automated algorithms (e.g., computer vision, artificial intelligence, image batch processing, etc.). For example, after generating or capturing views of a scene using a physical or virtual camera, one or more other views may be generated artificially by predicting, interpolating, or extrapolating from the original view. For example, various computer vision techniques may generate additional views based on one or more input views. This may involve employing a trained computer vision model that predicts, interpolates, and/or extrapolates different views from one or more input views.

When generating or capturing views of a scene using the camera 121, the multiview image may have a plane of convergence 127. A ‘plane of convergence’ or ‘convergence plane’ is defined as a set of locations where the different views align such that there is little to no disparity between the different views. The plane of convergence 127 may also be referred to as a Zero Disparity Plane (ZDP). The plane of convergence 127 occurs in front of the camera 121. Objects between the camera 121 and the plane of convergence 127 appear closer to the viewer while objects behind the plane of convergence 127 appear further away from the viewer. In this respect, the degree of disparity between the different views increases the further the object is positioned away from the plane of convergence 127. Objects along the plane of convergence 127 appear in focus with respect to the viewer. Thus, when generating a multiview image 115, the creator who wishes to feature certain objects as the primary subject may want the plane of convergence 127 to fall on the primary subject. Pixels rendered on the ZDP may appear as if they are located on the display, pixels rendered in front of the ZDP may appear as they are located in front of the display, and pixels rendered behind the ZDP may appear as if they are located behind the display.

The camera 121 captures a scene that falls within the frustum 130 of the camera 121. The frustum 130 is shown to have an upper bound and a lower bound that define the viewing angle range of the scene. Typically, the default plane of convergence 127 is parallel to the plane formed by the camera lens of the camera 121 such that it forms a trapezoid with respect to the frustum 130. In FIG. 2, the plane of convergence 127 intersects the bottom of the tree 118 and the back of the tree 118 (relative to the camera 121). As a result, the bottom of the tree 118 appears to be in focus and will appear as the featured point of interest to a viewer as it appears to be located on the display.

FIG. 2 also shows a disparity map 133 for one of the views of the multiview image 115. A disparity map 133 may be generated for at least one of the views. In some cases, a disparity map is not generated. In any case, a disparity map 133 is discussed to illustrate concepts related to embodiments discussed herein. A disparity map 133 associates each pixel (or potentially a cluster of pixels) to a corresponding disparity value. The disparity value quantifies the disparity in terms of distance relative to corresponding pixels of different views. For example, a pixel having a large disparity value for a first view means that, with respect to a corresponding pixel in a second view, there is a large difference in where the pixel and the corresponding pixel appear to the viewer from a particular viewing angle.

Herein a ‘disparity map’ is defined as information indicating an apparent pixel difference between at least two views of a multiview image 115. In this respect, a disparity map may indicate the difference in location between two pixels of two views of a multiview image. When disparity is zero (e.g., equal to zero or near zero) the pixels representing an object appear to the viewer at the same location. In other words, an object that is in focus by the user has zero disparity between multiple views (e.g., a left eye view and a right eye view). Areas where there is little to no disparity are considered to correspond to the plane of convergence 127 (or ZDP). Objects that appear in front or behind the object in focus will have disparity at varying degrees of disparity and are thus beyond the plane of convergence. For example, pixels representing objects between the camera 121 and the plane of convergence 127 may have positive disparity values while pixels representing objects behind the plane of convergence 127 may have negative disparity values. The larger the absolute value of disparity, the farther it is away from the plane of convergence 127. Disparity is inversely proportional to depth.

FIG. 2 shows the disparity map 133 having three regions 135a-c. Each region 135a-c encompasses pixels that represent various disparity values. For example, the lower region 135a corresponds to pixels representing the ground 120 in front of the tree 118, the middle region 135b corresponds to pixels representing the bottom of the tree 118, and the upper region 135c corresponds to pixels representing the top of the tree 118. The disparity values in the lower region 135a may be relatively large and positive as they represent pixels in front of the plane of convergence 127. The disparity values in the middle region 135b may be close to zero as they represent pixels on the plane of convergence 127. The disparity values in the upper region 135c may be relatively large and negative as they represent pixels behind the plane of convergence 127. When rendered on a multiview display, the multiview image 115 is perceived by a user so that there is a wide range of disparity with respect to the ground 120. In other words, only a small portion of the ground 120 will appear in focus and located on the display. The remaining portions of the ground 120 will appear in front of the display or behind the display. This result might be undesired in some applications. For example, multiview content that features a subject moving along the ground 120 or multiple subjects at varying positions on the ground may not be presented in an optimal manner to a viewer from a birds-eye view. In such cases, it may be desirable to tilt the plane of convergence.

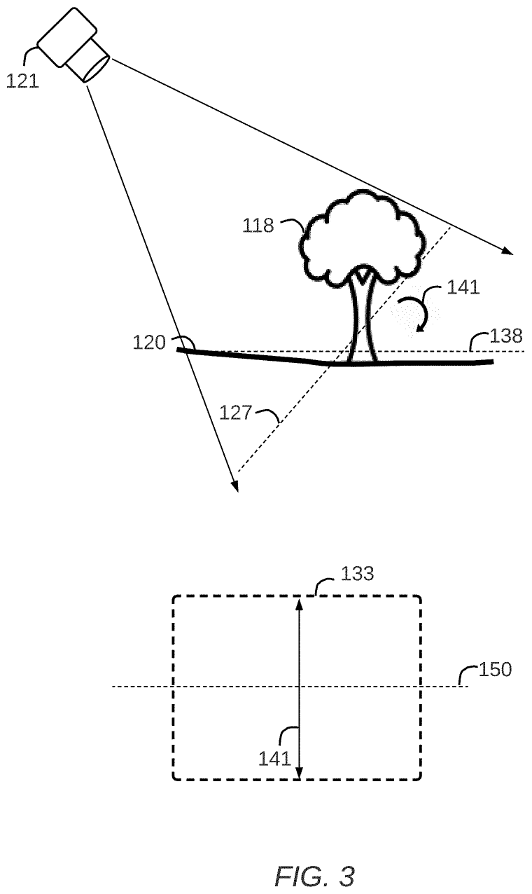

FIG. 3 illustrates an example of tilting the plane of convergence 127 of a multiview image according to an embodiment consistent with the principles described herein. For example, the plane of convergence 127, which is initially parallel with respect to the plane formed by the lens (virtual or physical) of the camera 121 may be tilted to form a tilted plane of convergence 138 that is not parallel with respect to the plane formed by the lens (virtual or physical) of the camera 121. FIG. 3 shows an amount of tilt 141 which may be quantified as an angle between the plane of convergence 127 (which may be referred to as the initial plane of convergence) and the tilted plane of convergence 138. The tilted plane of convergence 138 may be generated as a result of rotating the plane of convergence 127 about a point of rotation (shown at the intersection of the initial plane of convergence 127 and the tilted plane of convergence 138).

By applying a tilted plane of convergence 138, the multiview image may result in a more aesthetically pleasing viewing experience. For example, the tilted plane of convergence 138 may correspond to a plane formed by the ground 120. As a result, objects along the ground will have no disparity, thereby drawing the viewer's attention towards the ground as it spans the multiview image. For example, objects located on or near the ground will appear as if it is on the display, objects above the ground will appear in front of the display and objects below the ground will appear behind the display.

In terms of a mathematical relationship, the plane of convergence 127 may be tilted along the vertical (y) axis by modifying the disparity map according to the following equation (1):

D′(X,Y)=D(X,Y)+T*Y+C (1)

where ‘D’ refers to the disparity value, ‘D′’ refers to the updated disparity value, where the disparity value is a function of the X and Y coordinates of the pixel, where ‘T’ quantifies the amount of tilt 141, and ‘C’ corresponds to the location of the rotation of the plane of convergence 127 defined by a rotation axis 150. By applying the equation above to the disparity map 133, the disparity is modified along the vertical axis such that the further away from the rotation axis 150, the greater the change in disparity.

Modifying disparity maps 133 to create a tilted plane of convergence 138 may not be an option in some embodiments as disparity maps 133 might not be readily available. For example, in a real-time rendering environment, multiview images may be rendered and post-processed on the fly when there is no bandwidth or capability of generating disparity maps. To this end, operating on disparity maps might not allow for real-time rendering in a graphics pipeline. The following Figures describe using a graphics pipeline to tilt the plane of convergence 127 in a real-time rendering environment.

When generating or rendering multiview images, there are various visual properties or effects that control the way the image is displayed. These visual properties include, for example, disparity, depth of field (DoF), baseline, plane of convergence, convergence offset, transparency, etc. The visual properties of a multiview image may be applied at the time of rendering as a post-processing operation.

As used herein, ‘disparity’ is defined as the difference between at least two views of a multiview image at corresponding locations. For example, in the context of stereoscopic vision, the left eye and right eye may see the same object but at slightly different locations due to the difference in viewing angles between the eyes. This difference may be quantified as disparity. The change in disparity across the multiview image conveys a sense of depth.

As used herein, ‘depth of field’ is defined as the difference in depth between two objects that are considered to be in focus. For example, a large depth of field of a multiview image results in a small amount of disparity between a relatively large range of depths.

As used herein, ‘baseline’ or ‘camera baseline’ is defined as the distance between two cameras that capture corresponding views of a multiview image. For example, in the context of stereoscopic vision, the baseline is the distance between the left eye and right eye. A larger baseline leads to increased disparity and may enhance the 3D effect of the multiview image.

As used herein, ‘convergence offset’ refers to the distance between the camera and point along the plane of convergence. Modifying the convergence offset will change the location of the plane of convergence so as to refocus the multiview image on new objects at a different depth.

As used herein, ‘transparency’ refers to an object property that defines the degree in which other objects behind an object may be seen. Objects may be rendered as layers that form a finalized view of the multiview image. Increasing the transparency of a front layer will allow rear layers to be seen. A minimum transparency (e.g., no transparency) will prevent a rear layer from being seen while a maximum transparency will make the particular layer invisible so as to completely reveal the rear layer.

Further, as used herein, the article ‘a’ is intended to have its ordinary meaning in the patent arts, namely ‘one or more’. For example, ‘a processor’ means one or more processor and as such, ‘the memory’ means ‘one or more memory components’ herein.

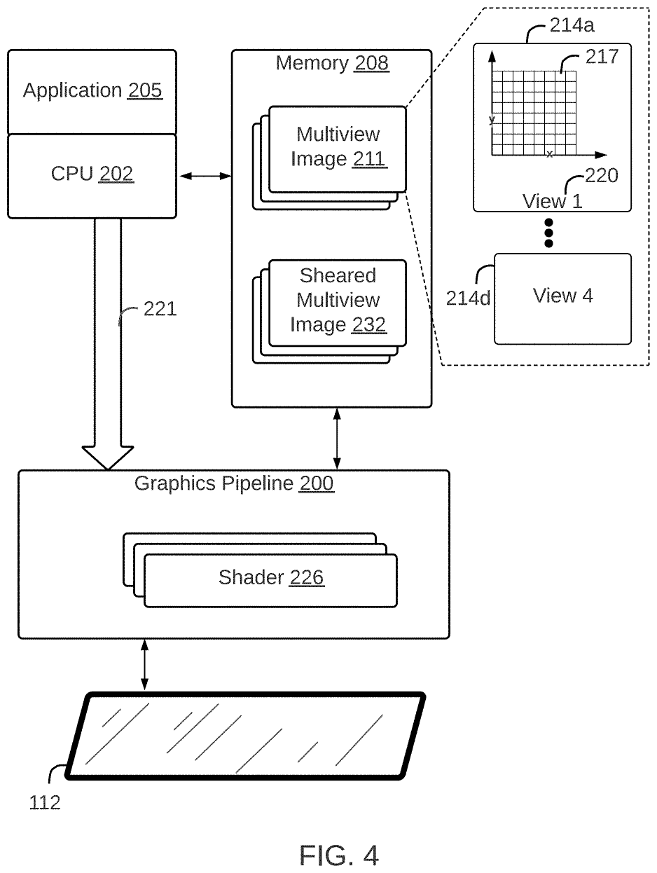

FIG. 4 illustrates an example of a computing system that tilts a plane of convergence of a multiview image according to an embodiment consistent with the principles described herein. Operations to tilt the plane of convergence may be take place in a graphics pipeline 200 without the use of a disparity map. FIG. 4 shows an embodiment of interfacing with a graphics pipeline 200 to tilt the plane of convergence. A ‘graphics pipeline,’ as used herein, is defined as a computer-implemented environment that renders a model to display. A graphics pipeline may include one or more Graphics Processing Units (GPUs), GPU cores, or other specialized processing circuits that are optimized for rendering image content to a screen. For example, GPUs may include vector processors that execute an instruction set to operate on an array of data in parallel. The graphics pipeline 200 may include a graphics card, graphics drivers, or other hardware and software used to render graphics. The graphics pipeline 200 may be configured to render images on a multiview display 112. The graphics pipeline 200 may map pixels onto corresponding locations of a display and control the display to emit light to render the image.

The computing system shown in FIG. 4 may also include one or more central processing units (CPUs) 202. A CPU 202 may be a generic processor that executes instructions, supports an operating system, and provides user level applications 205. In some embodiments, the graphics pipeline 200 is a subsystem that is separate from the CPU 202. For example, the graphics pipeline 200 may include specialized processors (e.g., GPUs) that are separate from the CPU 202. In some embodiments, the graphics pipeline 200 is implemented purely as software by the CPU 202. For example, the CPU 202 may execute software modules that operate as a graphics pipeline 200 without specialized graphics hardware. In some embodiments, portions of the graphics pipeline 200 are implemented in specialized hardware while other portions are implemented as software modules by the CPU 202.

The application 205 may be a user-level application that generates a user interface that is rendered by the graphics pipeline 200 for display on the multiview display 112. For example, the application 205 may be a navigation application that loads various maps depicting streets, buildings, and other geographic landmarks. A navigation application may provide a user interface that generates a 3D model of a geographic area. The navigation application may dynamically update a virtual camera's viewing angle in the 3D model to generate a visual output of a portion of the 3D model based on the virtual camera's orientation.

The computing system may also include memory 208. The memory 208 may include main memory (e.g., system memory), cache, or other fast memory for quickly processing data. The memory 208 may be volatile memory but may also include non-volatile memory, as discussed in further detail below. The memory 208 may include memory for the CPU 202 and memory for the graphics pipeline 200 such that the CPU 202 and graphics pipeline 200 share the same memory resources. In some embodiments, the memory 208 includes a first memory (e.g., CPU memory) that is dedicated to the CPU and includes second memory (e.g., GPU memory, texture memory, etc.) that is dedicated to the graphics pipeline 200. In this embodiment, the graphics pipeline 200 may load, copy, or otherwise move content from CPU memory to GPU memory.

As discussed above the application 205 may generate a 3D model using computer graphics techniques for 3D modeling. A 3D model is a mathematical representation of various surfaces and textures of different objects and may include the spatial relationship between the objects. The application 205 may generate and update the 3D model depending on user input. The user input may involve navigating though the 3D model by clicking or dragging a cursor, pressing direction buttons, converting the user's physical location to a virtual location within the 3D model, etc. The 3D model may be loaded into memory 208 and updated thereafter.

The 3D model may be converted into multiview images 211 revealing a window into the 3D model. The window may be defined by a virtual camera having a set of coordinates within the 3D model, a viewing angle, a focus length, a baseline, etc. A sequence of multiview images 211 may form a video that is displayed at a particular frame rate (e.g., 30 frames per second). Each multiview image 211 may be made up of multiple views 214a-d. The example of FIG. 4 shows a multiview image 211 formatted as a four-view image with four views, however, any number of views may be used. The views 214a-d may be configured to provide horizontal disparity, vertical disparity, or both. For example, when there is horizontal disparity, the views 214a-d appear to change as a viewer moves from left to right with respect to the multiview display 112.

The application 205 may load a view 214a-d of the multiview image 211 into memory 208. For example, the application 205 may be configured to convert the 3D model into a rendered scene for showing a multiview image 211 derived from the 3D model. One or more views 214a-d are generated by the application 205 and placed into a particular block of the memory 208. The view 214a-d may be formatted as a bitmap 217 defined by a pixel coordinate system. For example, the view 214a-d may be expressed as a two-dimensional array of bitmaps along a horizontal (X) axis and a vertical (Y) axis. Each pixel in the bitmap 217 has a corresponding location on the display. For example, the upper left-most pixel of the bitmap 217 controls the output of the upper left-most pixel of the display. In addition, each view 214a-d may have a corresponding view index number 220. The view index number 220 may be an ordered view number of the view within the multiview image 211. For example, in a four-view multiview format, each of the four views may be numbered one, two, three, and four. The view index number 220 indicates the position of the view relative to other views. For example, View One may be the left-most view, View Two may be the left-center view, View Three may be the right-center view, and View Four may be the right most view. The greatest disparity, in this case, would be between View One and View Four.

Once the views 214a-d are generated and loaded into memory 208, the application 205 may invoke a render command 221 to the graphics pipeline 200. The render command 221 instructs the graphics pipeline 200 to begin rendering the multiview image 211. The render command 221 may be a function call to the graphics driver to cause the graphics pipeline 200 to render the multiview image 211. The render command 221 may identify the specific multiview image 211 to be rendered. For example, the render command 221 may identify the address block of where the multiview image 211 is stored.

The graphics pipeline 200 may include one or more shaders 226 to render the multiview image 211. A shader 226 may be a hardware device (e.g., a shader core), a software module, or a combination thereof. A shader 226 may be executed by the GPU of the graphics pipeline 200. An initial rendering of the multiview image 211 may be performed by a module that performs various techniques such as, for example, rasterization, to render a simple or rough version of the multiview image 211. The initial rendering operation may be a quick, highly efficient operation, to convert the scene geometry into pixels for display. The initial rendering may not include more advanced optically advanced effects. In some embodiments, a shader 226 may be used in the initial rendering.

After the initial rendering is performed, one or more advanced optical effects may be applied to the initially rendered multiview image. An optical effect may be applied using one or more shaders 226. By operating on an initially rendered multiview image 211, the shader 226 is considered to implement a post-processing effect. As used herein, ‘post-processing’ is defined as an operation performed on an image that is initially rendered as part of the rendering process in a graphics pipeline 200. Different shaders 226 may be configured to perform post-processing. Some examples of post-processing include, but not limited to, modifying color saturation, modifying hue, adjusting the brightness, adjusting the contrast, applying a blur, performing volumetric lighting, applying a depth effect, performing cell shading, generating a bokeh effect, applying or one or more filters. As used herein, a ‘shader’ is defined is a graphics component in a graphics pipeline that applies a specific graphics operation including, for example, initial rendering or post-processing.

The application 205 may interface with the graphics pipeline 200 using one or more Application Programming Interfaces (API). One example of an API is OpenGL, which provides an interface to allow applications 205 to call functions performed in the graphics pipeline 200. For example, an API may be used by the application 205 to invoke a particular shader 226 that performs post-processing on an initially rendered multiview image 211.

Embodiments are directed to implementing functionality in the graphics pipeline 200 to tilt the plane of convergence during real-time rendering. The following provides an example of the functionality and operations that may take place in the computing system. As discussed above the application 205 may generate and load a view 214a-d of the multiview image 211 into memory 208. The application 205 executing on an operating system may instruct the CPU to load the view 214a-d into a block of memory 208.

The view 214a-d may be formatted as a bitmap 217 defined by a pixel coordinate system. The view 214a-d may be generated from a 3D model by identifying a particular viewpoint and viewing angle of the 3D model and converting it into a bitmap 217. This may be performed for each view of the multiview image 211. The application 205 may then invoke a render command 221 to initially render the views 214a-d of the multiview image 211. For example, the application 205 may use an API to request the graphics pipeline 200 to perform an initial rendering. In response, the graphics pipeline 200 may generate initially rendered views 214a-d by performing, for example, rasterization. In a real-time graphics rendering environment, the graphics pipeline 200 may be optimized to quickly render views 214a-d on the fly. This provides a seamless experience to the viewer as new multiview images 211 are dynamically generated (and are not pre-rendered).

Next, the application 205 is configured to tilt the plane of convergence in real time. For example, the application 205 may identifying a distance between the view 214a-d and a center point of view. Assuming the case where the different views 214a-d have varying degrees of horizontal disparity with respect to a center point of view, the distance between each view and the center point of view along the horizontal axis may be determined. This distance is dependent on the baseline (e.g., the distance between views). For example, the larger the baseline, the greater the distance from a center point of view. In some embodiments, the distance between the view 214a-d and the center point of view is identified by determining an ordered view number (e.g., the view index number 220) of the view 214a-d within the multiview image 211. For example, if the views 214a-d of the multiview image 211 are ordered from one through four, with View One being positioned at the left-most side and View Four being positioned at the right-most side. The view index number 220 corresponds to distance between the view 214a-d and the center point of view. For example, a view index number 220 of one may correspond to a distance of 50 pixels left of the center, a view index number 220 of two may correspond to a distance of 25 pixels left of the center, a view index number 220 of three may correspond to a distance of 25 pixels right of the center, and a view index number 220 of four may correspond to a distance of 50 pixels right of the center. The distance from the center may be a signed number (e.g., positive or negative) to indicate whether the view is left of the center. For example, a negative distance may indicate that the view is left of the center while a positive distance may indicate that the view is to the right of the center.

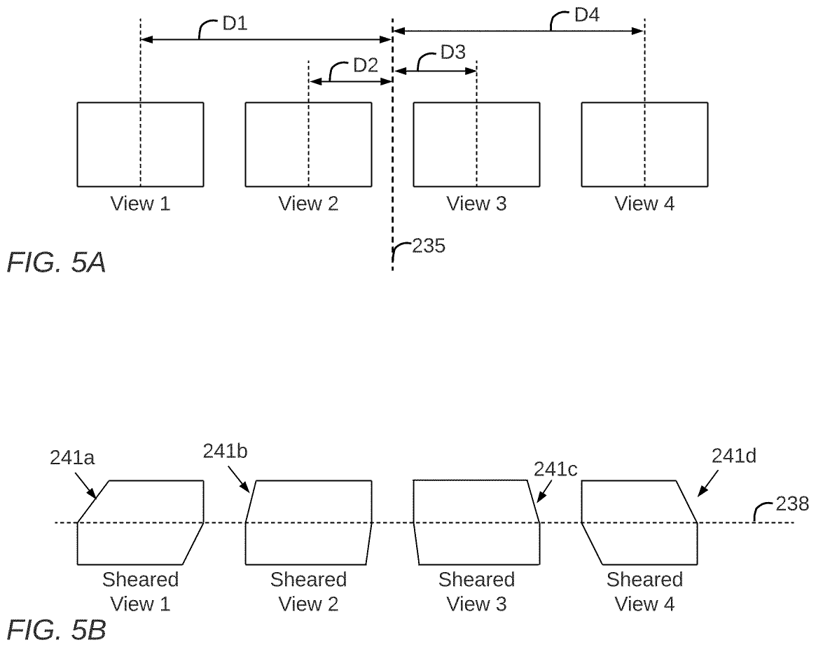

Determining the view 214a-d distance from the center point of view is part of determining how to tilt the plane of convergence in the real-time graphics pipeline 200. The application 205 may generate a render instruction to tilt the plane of convergence by using a shear function. The application 205 may transmit to the graphics pipeline 200 an instruction to render the view as a sheared view. In this respect, the application 205 may invoke an instruction for post-processing an initially rendered multiview image to be sheared according a shear function applied along an axis of the pixel coordinate system. Specifically, the graphics pipeline 200 may render the view 214a-d in the graphics pipeline 200 as a sheared view according to the shear function. A shear strength of the shear function correlates with the distance between the view 214a-d and the center point of view. A ‘shear function,’ as used herein, is defined as a graphics operation that displaces pixels of an image along a direction according to a shear strength. The shear strength quantifies that amount of shear effect that is applied by a shear function to an image. The shear strength of the shear function may correlate with a position of the view relative to other views in the multiview image. FIG. 5, discussed below, provides a visual explanation of the shear function.

Executing the shear function causes the plane of convergence to be tilted in real time as the multiview image 211 is rendered in the graphics pipeline. A shader 226 may be customized to implement the shear function. In this respect, the application 205 may call a shader 226 to perform the shear function on an initially rendered multiview image 211. After applying the shear function on the views 214a-d of the multiview image, the graphics pipeline 200 may load the result into memory 208 as a sheared multiview image 232. The graphics pipeline 200 may override the multiview image 211 with the sheared multiview image 232 or may load the sheared multiview image 232 in a separate portion of the memory 208. Additional post-processing may be applied to the sheared multiview image 232 before it is finally rendered on the multiview display 112.

FIGS. 5A and 5B illustrate an example of applying a shear function, according to an embodiment consistent with the principles described herein. FIG. 5A depicts different views of a multiview image. Each view may be formatted as a bitmap image stored or loaded in memory such as, for example the memory 208 of FIG. 4. While four views are shown, the multiview image may have any number of views. The views shown in FIG. 5A (e.g., View 1, View 2, View 3, and View 4) have horizontal disparity. The multiview image of FIG. 5A may have a center point of view 235. The viewer may see around objects in the multiview image by moving along the horizontal axis (e.g., from left to right or right to left).

Each view may have a corresponding distance to the center point of view 235. While FIG. 5A shows this distance measured from the center of each view, the distance may be measured from any point of the view such as, for example, the left edge or the right edge. View 1 is distanced at a distance of ‘D1’ away from the center point of view 235. View 2 is distanced at a distance of ‘D2’ away from the center point of view 235. View 3 is distanced at a distance of ‘D3’ away from the center point of view 235. View 4 is distanced at a distance of ‘D4’ away from the center point of view 235. The distances D1 and D2 may be negative values indicating that it is left of the center point of view 235 while the distances D3 and D4 may be positive values indicating that it is right of the center point of view 235.

FIG. 5A shows the multiview image as it is loaded in memory as well as how it appears as it is initially rendered by a graphics pipeline before post-processing. FIG. 5B illustrates the multiview image after it is sheared by a shear function as part of post-processing in a real-time graphics pipeline (e.g., graphics pipeline 200 of FIG. 4). Specifically, FIG. 5B shows Sheared View 1 generated from View 1, Sheared View 2 generated from View 2, Sheared View 3 generated from View 3, and Sheared View 4 generated from View 4. Each of the Sheared Views 1-4 are generated by a shear function that applies a shear strength. The shear strength is determined based on the distance between the view and the center point of view 235 (e.g., D1-D4). For example, the larger the distance away from the center point of view 235, the greater the shear strength. In addition, the sign of the shear strength (e.g., positive or negative) is defined by the sign of the distance. The sign of the shear strength controls the direction of shear applied by the shear function.

The shear function may also be defined by a shear line 238. The shear line 238 may extend along a particular axis which controls how each view is sheared. The shear function operates according to the shear line 238. The example of FIG. 5B shows the shear line 238 along the horizontal axis. As a result, the shear function is configured to skew the view only along the horizontal axis of the pixel coordinate system. In this respect, pixels on the pixel coordinate system are displaced only horizontally. The direction and degree of pixel displacement is dependent on the view's distance to the center point of view 235 (e.g., either a positive or negative distance) as well as whether the pixel being displaced is above or below the shear line 238. For example, in Sheared View 1 and Sheared View 2, pixels above the shear line 238 are skewed to the right while pixels below the shear line 238 are skewed to the left. In Sheared View 3 and Sheared View 4, pixels above the shear line 238 are skewed to the left while pixels below the shear line 238 are skewed to the right.

FIG. 5B also illustrates a shear effect 241a-d for the corresponding Sheared Views 1-4. A stronger shear effect will cause the view to be sheared more. The shear effect is determined by the shear strength such that a large shear strength will lead to a greater shear effect 241a-d. For example, the shear strength may be based on the amount of tilt of the plane of convergence. In addition, the shear strength increases as the view moves away from the center point of view 235. For example, the shear effect 241a of Sheared View 1 is stronger than the shear effect 241b of Sheared View 2 because Sheared View 1 is farther away from the center point of view 235. In addition, the shear effect 241a of Sheared View 1 is similar to the shear effect 241d of Sheared View 4 because Sheared View 1 and Sheared View 4 are equidistant to the center point of view 235. However, Sheared View 1 and Sheared View 4 have opposite directions of the shear effect 241a, 241d because they are on opposing sides of the center point of view 235.

The shear line 238 may be form a horizontal line positioned in the middle along the vertical axis as a default. In other embodiments, the shear line 238 may be located at varying vertical locations and may be user-specified. While FIG. 5B shows a horizontal shear line 238, the shear line 238 may be vertical. In this embodiment, the shear function is configured to skew the first view and second view along the vertical axis of the pixel coordinate system. In some embodiments, the shear line 238 is sloped or curved so that it has points that change along the horizontal axis and vertical axis. In this example, pixels may be displaced along both the X and Y directions.

One embodiment contemplates using a navigation application to dynamically generate multiview images of map scenes as a user is navigating a physical or virtual space. If the camera angle is similar or close to a bird's-eye view, the plane of convergence may be tilted about a horizontal axis. As a result, the shear function is configured to skew the view only along the horizontal axis of the pixel coordinate system.

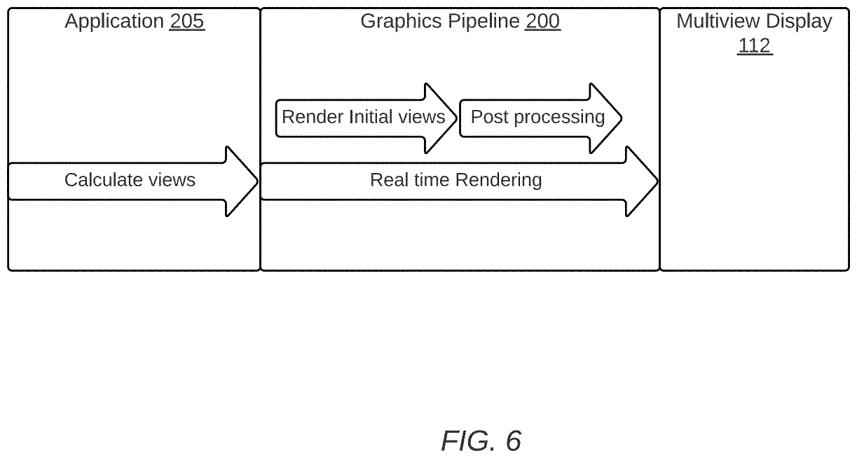

FIG. 6 illustrates an example of interfacing with a graphics pipeline according to an embodiment consistent with the principles described herein. As discussed above, the application 205 may interface with the graphics pipeline 200. For example, the application 205 may be a user-level application that executes on an operating system of a client device. The application 205 may also be implemented a cloud-based application that executes on a server and is provided via a client device to a user. The application 205 may interface with a graphics pipeline 200 using one or more APIs. The application 205 is responsible for calculating the views. The views may be calculated from a 3D model dynamically as a user provides input. For example, the user may provide instructions or input to change the perspective, zoom, orientation, or position of a camera that captures a scene defined by a 3D model. In response, the application 205 may calculate the views of the multiview image in real time. In this case, the multiview image may be a frame of a video that is to be rendered in a real-time graphics pipeline.

The views of the multiview image maybe calculated dynamically in response to user interaction. The application 205 may generate a command to the graphics pipeline 200 to perform real-time rendering of any or all views as they are being calculated by the application 205. For example, the application 205 may transmit an API function call to the graphics pipeline 200 to render the views.

The real-time rendering may include an initial render portion and a post-processing portion. The initial render portion involves the graphics pipeline 200 to render initial views. As discussed above, the views are initially rendered to quickly render the pixel of the multiview image on the display without advanced optical effects. A shader may be used to perform the initial rendering. Thereafter, the application 205 may invoke one or more post-processing operations to convert the initial rendering into a final rendering. The post-processing may apply image-editing operations that improve the quality or realism of the initially rendered image. According to embodiments, the application 205 instructs the graphics pipeline 200 to tilt the plane of convergence. For example, the graphics pipeline 200 applies a shear function to each of the views. A shear strength of the shear function correlates with a position of the view relative to other views in the multiview image. A shader may be used to implement the shear function. The application 205 may provide a shear strength, a shear line, or both as an input to the graphics pipeline. The sheared views of the multiview image are then rendered on the multiview display 112. This process occurs continuously as the application 205 generates new multiview images to be rendered in real time.

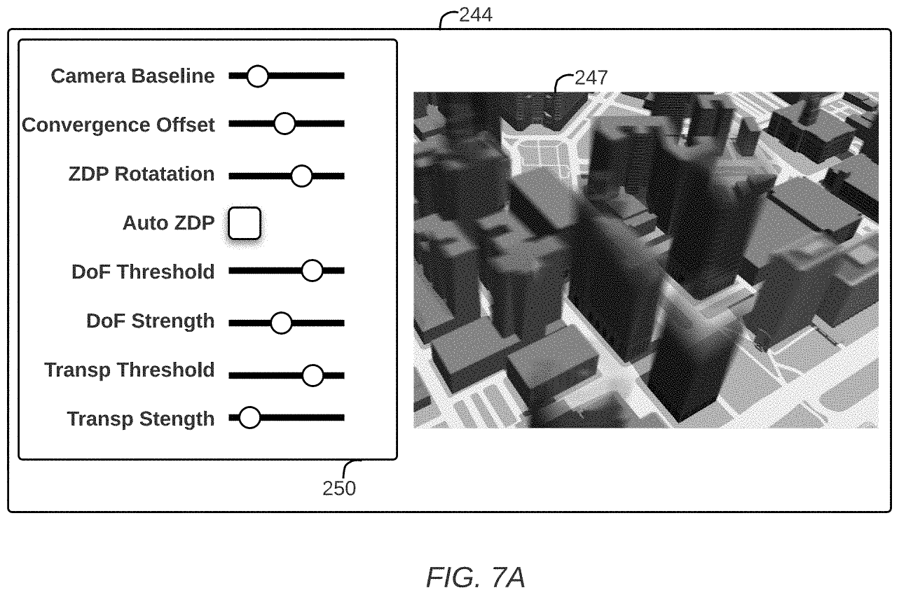

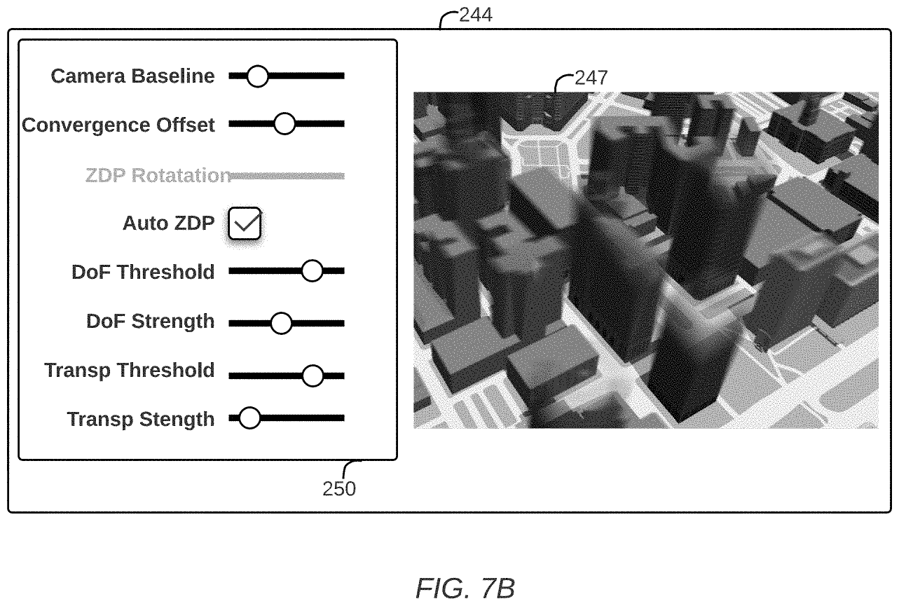

FIGS. 7A and 7B illustrate examples of a user interface 244 to configure the rendering of a multiview image according to embodiments consistent with the principles described herein. There are generally two modes of software development and use: configuration mode and run time mode. Configuration mode refers to the mode where developers create and configure software applications. For example, an application may allow a developer to create a navigation application during configuration mode. The developer may specify desired camera angles, post-processing operations, and other aspects of how multiview images are to be rendered. Run time mode refers to the mode where end users execute the software that has been configured by developers.

The user interface 244 may be rendered on a client device and used by a developer during configuration mode who is developing an application that eventually renders multiview images during run time mode. The user interface may comprise a window containing information (e.g., text and graphics) presented to a user. The user interface 244 may be generated by an application used to design end-user applications. For example, the user interface 244 may be used by developers to design navigation applications, gaming applications, or other applications. The user interface 244 may be used by developers who design graphics and the way they are presented to other users. The user interface 244 may also be rendered by an end-user application. The user interface 244 may allow a user to configure shaders during a configuration mode by making user selections relating to different post-processing operations. Once the shaders are configured according to the user input, the shaders may post-process multiview images in run time.

The user interface 244 may have a first portion 247 for displaying a multiview image or a representation thereof. The first portion 247 may include a rendering of a multiview image. For example, the rendering of the multiview image may simulate how the user settings would apply to multiview images during run time. The user interface 244 may have a second portion 250 that contains a menu. The menu may include various input elements such as, for example, sliders, text boxes, check boxes, radio buttons, dropdown menus, etc.). The menu allows a user to change various visual parameters of the multiview image as it is rendered in the first portion. These visual parameters include, for example, the camera baseline, the convergence offset, a ZDP rotation, an auto ZDP option, a Depth of Field (DoF) Threshold, a DoF strength, a transparency threshold, a transparency strength, and potentially other visual parameters. A user may provide input by manipulating one or more input elements. As a result, user input is received from the user interface 244.

FIG. 7A depicts an example of receiving user input from a user interface and determining the shear strength based on the user input. For example, a user may slide a ZDP rotation slider to select a range of ZDP rotation. When set to a minimum (e.g., zero rotation) such that the slider is on one end, the plane of convergence is not rotated. When set to a maximum value by moving the slider to the other end, the plane of convergence is tilted in a corresponding manner. That is, the amount of a user-specified ZDP rotation is used to determine the amount of tilt. This may quantify the strength of shear when applying the shear function during run time.

The shear function may also calculate the strength of shear according to the baseline that may be user-specified. The baseline controls the distance between each view and a center point of view by increasing the distance between at least two views. Thus, increasing the baseline may move a view farther away from the center point of view, thereby causing that view to experience a stronger shear effect. To this end, outer views will be sheared to a greater extent to achieve the effect of tilting the plane of convergence.

FIG. 7B depicts illustrates an example of a user interface that allows a user to select an option to automatically determine the amount of tilting of the plane of convergence during configuration mode. For example, an application may automatically determine the shear strength by calculating a disparity value at a common point among the view and another view of the multiview image. For example, the application may identify a feature at a predetermined location. The feature may be a pixel, or a collection of pixels having a common color. The predetermined location may be a midpoint along the horizontal or vertical axis of the view. The application may identify the location of the corresponding feature in another view to determine the amount it has shifted due to the different view angle of the other view. The application may invoke a raycast operation to identify the feature at the predetermined location. Raycasting refers to projecting a hypothetical ray from a particular angle towards a particular location of a 3D model. The output identifies a feature of the 3D model. Raycasting may be used to determine the disparity between different views from a 3D model. The amount that a feature is displaced between two views equates to the disparity. Once the disparity between two views is identified at a particular location, an optimal shear strength may be determined so that the disparity at that particular location is removed as a result of tilting the plane of convergence. In this respect, tilting the plane of convergence using the calculated shear strength will result in the views aligning at the predetermined location so that there is no disparity.

FIGS. 7A and 7B also show a user interface for selectively applying post-processing operations. In some embodiments, post-processing operations may be applied to selected regions of the multiview image. For example, an application may be configured to receive user input from a user interface, determine a range of disparity values based on the user input, and configure a shader to operate on pixels of the view in response to the pixels having disparity values within the range of disparity values. The user interface 244 may include a menu for selecting a threshold such as, for example, a DoF threshold, a transparency threshold, or a threshold for other post-processing operations. The threshold may be a range of values that correspond to a range of disparity. A low threshold may encompass regions of the view corresponding to a low amount of disparity (e.g., zero or near zero disparity). A higher threshold may encompass regions of the view corresponding to a large amount of disparity such that the entire view is selected. The threshold selection expands the selection of the view in both directions (in and out) of the zero disparity plane. Thus, based on a threshold selection, the application may determine a range of disparity values and select those regions in the view that fall within the range of disparity values.

After selecting the regions of the view, the application applies a shader operation (e.g., a post-processing operation) only to the selected regions. The shader is configured to perform a transparency operation or a depth of field operation, or potentially other post-processing operations. A transparency operation changes the degree in which other objects behind an object may be seen. This degree may be user-specified using the user interface. For example, as shown in FIGS. 7A and 7B, a user may specify a transparency strength to control the degree of transparency for pixels within the transparency threshold. A shader that performs a transparency operation is configured according to the transparency strength and operates on selected pixels defined by the transparency threshold.

A depth of field operation modifies the difference in depth between two objects that are considered to be in focus. For example, the depth of field operation may change the disparity values for the pixels within the selected pixels. For example, if the depth of field threshold selects pixels having disparity values between −30 and +30, a large depth of field strength may specify the degree of blurriness applied to the selected pixels. The depth of field operation blurs the selected pixels in a manner that corresponds to the depth of field strength.

The user interface 244 allows a user to make particular selections for thresholds and post-processing operation parameters. These settings are used to configure shaders. During run time, the shaders operate according to the settings applied via the user interface 244.

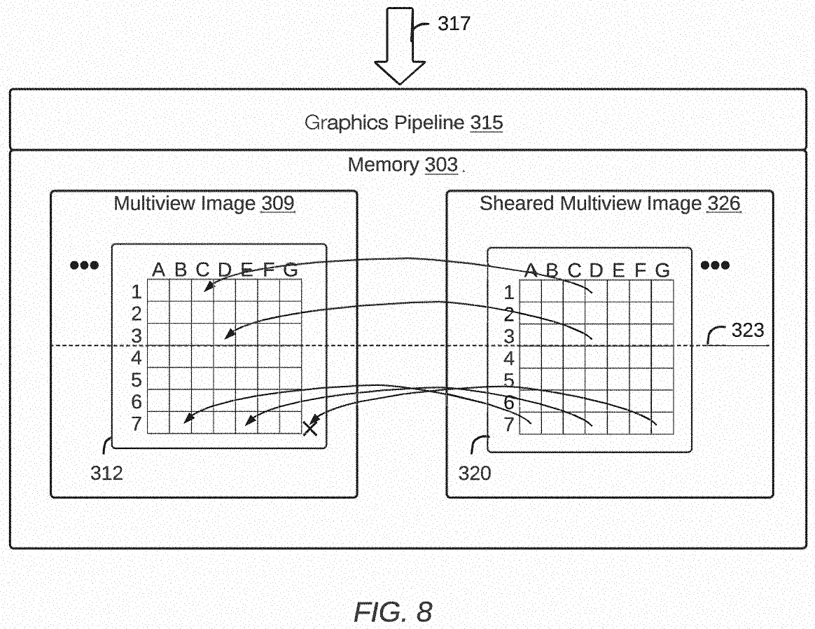

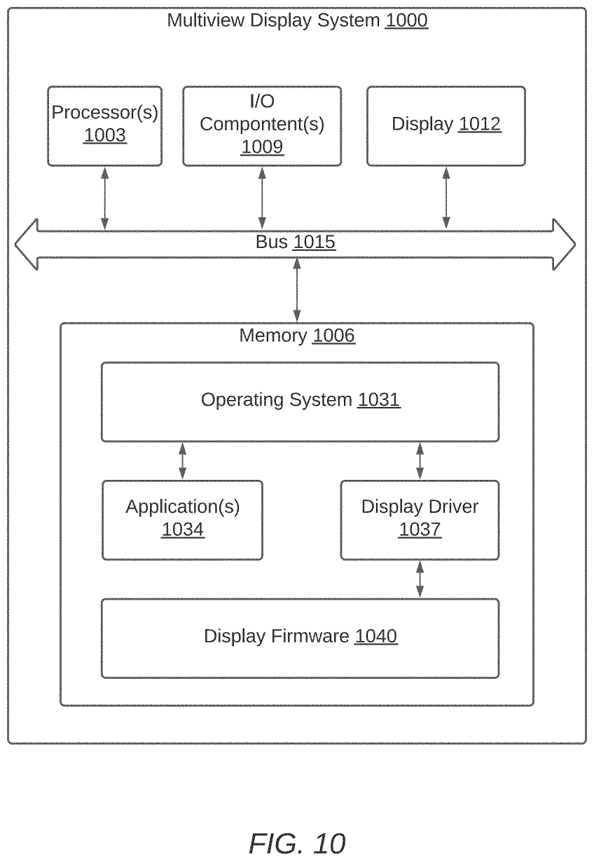

FIG. 8 illustrates an example of a computing system that applies a shear function as pixels are sampled according to an embodiment consistent with the principles described herein. FIG. 8 depicts a computing system including at least a processor and a memory 303, where the memory 303 stores a plurality of instructions, which, when executed, cause the processor to perform various operations. The memory 303 may be similar to the memory 208 of FIG. 4. An example of this computing architecture showing a processor and memory is descried in greater detail with respect to FIG. 10.

The computing system may load a view of the multiview image into the memory 303. For example, as discussed above with respect to FIG. 4, an application (e.g., application 205), may generate one or more multiview images 309 and load the different views 312 in memory 303 in real time. The view 312 may be formatted as a bitmap defined by a pixel coordinate system. As shown in FIG. 8, the bitmap may have a horizontal (X) axis and a vertical (Y) axis. For purposes of illustration, each pixel may be referenced by a column letter (A-G) and a row number (1-7). The upper left-most pixel is referred to as pixel A1 of the view 312. It should be understood that the number of pixels for each view 312 may be significantly larger than the number of pixels shown in FIG. 8.

Next, the computing system may transmit to the graphics pipeline 315 an instruction to render the view (render instruction 317) as a sheared view 320 according a shear function applied along an axis 323 of the pixel coordinate system. The graphics pipeline 315 may be similar to the graphics pipeline 200 of FIG. 4. The render instruction 317 may be an API function call to render the view as a sheared view 320 by invoking a shader that is configured to apply a shear function. The sheared view 320 is part of a seared multiview image 326 such that each view 312 has a corresponding sheared view 320. The render instruction 317 may identify the view to be sheared. The render instruction 317 may be an instruction transmitted in real time to the graphics pipeline 315 to render multiview images 211 as they are dynamically generated by an application. The shear function may be implemented by a shader such as, for example, the shader 226 of FIG. 4. The shader may be configured during a configuration mode by a user using a user interface such as, for example, the user interface 244 of FIGS. 7A and 7B.

A shear strength of the shear function correlates with a position of the view 312 relative to other views in the multiview image 309. For example, a view index number may identify the position of the view 312 relative to other views. As explained above, in some embodiments, the shear strength may be determined by a user during a configuration mode who provides user input via a user interface. A shear strength is determined from the user input and is applied during run time.

The graphics pipeline 315 is configured to implement the shear function as pixels of the bitmap are sampled by the graphics pipeline 315. For example, the shear function may involve forming the sheared view by sampling pixels from the view 312. Rather than uniformly sampling in a one-to-one correspondence, the shear function samples pixels along a shear line using a shear strength to cause a shear effect. For example, the shear function operates according to an axis 323 that forms a shear line. Pixels of the sheared view 320 are sampled from locations that are close to the corresponding locations of the view 312. As pixels of the sheared view 320 move farther away from the axis 323 (in the vertical direction), the amount of horizontal displacement increases with respect to where the pixel is being sampled.

To illustrate, pixel D3 of the sheared view 320 is close to the axis, which is near rows 3 and 4. This pixel of the sheared view 320 is sampled from pixel D3 of the view 312. This amounts to no shear effect as pixel sampling is performed at the same corresponding location. However, as pixels are located further upwards in the vertical direction, the shear effect becomes more apparent. Pixel D1 of the sheared view is sampled from pixel Cl of the view 312. In this respect, the pixels north of the axis 323 are skewed to the right. This is a sampling offset that causes the shear effect to be applied to the sheared view. Similarly, pixel D7 of the sheared view 320 is sampled from pixel E7 of the view 312. The pixels south of the axis 323 are skewed to the left. This skewing function may lead to sampling pixels at invalid locations when operating near specific edges of the view 312. For example, pixel G7 of the sheared view 320 is sampled from a location outside of the view (shown as an X). In this case, a default pixel may be used to generate the pixel for G7 of the sheared view 320. The default pixel may be a pixel with a zero color value (e.g., a black pixel) or may have any other default pixel value. In some embodiments, the default pixel value may be determined by matching to the closest pixel that is in bounds.

FIG. 8 shows a shear function that is configured to skew the view 312 only along the horizontal axis (e.g., axis 323) of the pixel coordinate system. However, any axis orientation may apply. In addition, as discussed above with respect to FIGS. 7A and 7B the post-processing operations (including tilting the plane of convergence) may be configured during configuration mode using a user interface (e.g., user interface 244). Thereafter, the shear function may be applied during run time in graphics pipeline 315.

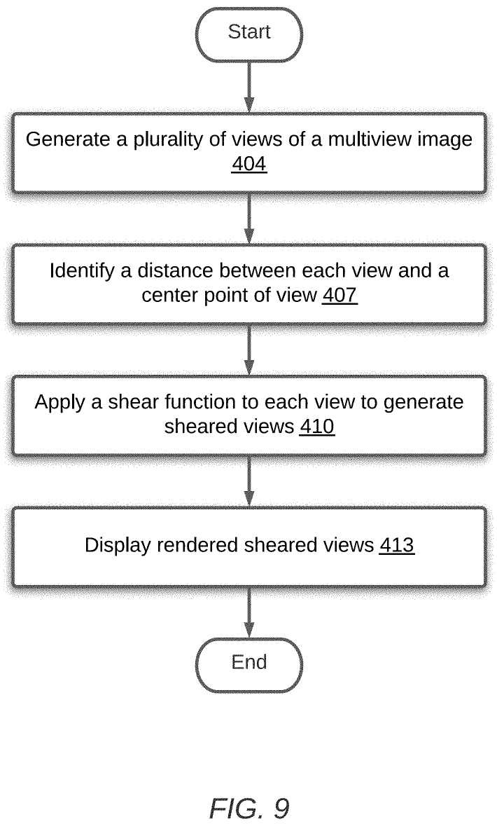

FIG. 9 is a flowchart illustrates a flowchart of a system and method of tilting a plane of convergence of a multiview image according to an embodiment consistent with the principles described herein. The flowchart of FIG. 9 provides one example of the different types of functionality implemented by a computing device (e.g., a multiview display system) executing an instruction set. As an alternative, the flowchart of FIG. 9 may be viewed as depicting an example of elements of a method implemented in a computing device according to one or more embodiments.

At item 404, the computing device generates a plurality of views of a multiview image. For example, an application (e.g., application 205 of FIG. 4) may generate the views of a multiview image dynamically in response to user input. The application may load the views into memory (e.g., memory 208 of FIG. 4, memory 303 of FIG. 8).

At item 407, the computing device identifies a distance between each view and a center point of view. For example, an application may identify this distance based on the view index number that indicates the position of each view relative to another view. The view index number may indicate whether the view is to the right or left of the center and how close it is to the center as index numbers are ordered. The distance may also be calculated according to the baseline. In the event that the baseline is predetermined, the view index number may be sufficient to infer the distance between a view and a center point of view.

At item 410, the computing device applies a shear function to each view to generate sheared views. For example, a graphics pipeline (e.g., graphics pipeline 200 of FIG. 4, memory 303 of FIG. 8) may be instructed by the application to apply a post-processing shear function. The graphics pipeline may render the first view in the graphics pipeline as a first sheared view according a first sheared strength of a shear function applied along an axis of the pixel coordinate system. The graphics pipeline may render the second view in the graphics pipeline as a second sheared view according a second sheared strength of the shear function applied along the axis of the pixel coordinate system. The first shear strength and second shear strength are different and are based on the distance between a view and a center point of view. For example, the first shear strength may be a negative shear strength and the second shear strength may be a positive shear strength. The sign of the shear strength controls the direction of shear applied to the view, which is dependent on the relative position of the view with respect to the center point of view.

At item 413, the computing device displays the rendered sheared views. The sheared views effectively have a tilted plane of convergence controlled by the amount of shearing applied to each view. The views may be rendered as a multiview image on a multiview display. For example, a graphics pipeline may communicate with the multiview display using, for example, graphics drivers and/or firmware to cause the multiview image to be rendered for display.

The flowchart of FIG. 9 discussed above may illustrate a system or method of tilting a plane of convergence in real time having the functionality and operation of an implementation of an instruction set. If embodied in software, each box may represent a module, segment, or portion of code that comprises instructions to implement the specified logical function(s). The instructions may be embodied in the form of source code that comprises human-readable statements written in a programming language, object code that is compiled from source code, or machine code that comprises numerical instructions recognizable by a suitable execution system, such as a processor a computing device. The machine code may be converted from the source code, etc. If embodied in hardware, each block may represent a circuit or a number of interconnected circuits to implement the specified logical function(s).

Although the flowchart of FIG. 9 shows a specific order of execution, it is understood that the order of execution may differ from that which is depicted. For example, the order of execution of two or more boxes may be scrambled relative to the order shown. Also, two or more boxes shown may be executed concurrently or with partial concurrence. Further, in some embodiments, one or more of the boxes may be skipped or omitted.

FIG. 10 is a schematic block diagram that depicts an example illustration of a multiview display system 1000 providing a multiview display according to an embodiment consistent with the principles described herein. The multiview display system 1000 may include a system of components that carry out various computing operations for a user of the multiview display system 1000. The multiview display system 1000 may be a laptop, tablet, smart phone, touch screen system, intelligent display system, or other client device. The multiview display system 1000 may include various components such as, for example, a processor(s) 1003, a memory 1006, input/output (I/O) component(s) 1009, a display 1012, and potentially other components. These components may couple to a bus 1015 that serves as a local interface to allow the components of the multiview display system 1000 to communicate with each other. While the components of the multiview display system 1000 are shown to be contained within the multiview display system 1000, it should be appreciated that at least some of the components may couple to the multiview display system 1000 through an external connection. For example, components may externally plug into or otherwise connect with the multiview display system 1000 via external ports, sockets, plugs, or connectors.

A processor 1003 may be a central processing unit (CPU), graphics processing unit (GPU), any other integrated circuit that performs computing processing operations, or any combination thereof. The processor(s) 1003 may include one or more processing cores. The processor(s) 1003 comprises circuitry that executes instructions. Instructions include, for example, computer code, programs, logic, or other machine-readable instructions that are received and executed by the processor(s) 1003 to carry out computing functionality that are embodied in the instructions. The processor(s) 1003 may execute instructions to operate on data. For example, the processor(s) 1003 may receive input data (e.g., an image), process the input data according to an instruction set, and generate output data (e.g., a processed image). As another example, the processor(s) 1003 may receive instructions and generate new instructions for subsequent execution. The processor 1003 may comprise the hardware to implement a graphics pipeline (e.g., graphics pipeline 200 of FIG. 4, graphics pipeline 315 of FIG. 8). For example, the processor(s) 1003 may comprise one or more GPU cores, vector processors, scaler processes, or hardware accelerators.

The memory 1006 may include one or more memory components. The memory 1006 is defined herein as including either or both of volatile and nonvolatile memory. Volatile memory components are those that do not retain information upon loss of power. Volatile memory may include, for example, random access memory (RAM), static random access memory (SRAM), dynamic random access memory (DRAM), magnetic random access memory (MRAM), or other volatile memory structures. System memory (e.g., main memory, cache, etc.) may be implemented using volatile memory. System memory refers to fast memory that may temporarily store data or instructions for quick read and write access to assist the processor(s) 1003. The memory 1006 may include the memory 208 of FIG. 4 or the memory 303 of FIG. 8, or one or more other memory devices.

Nonvolatile memory components are those that retain information upon a loss of power. Nonvolatile memory includes read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive. The ROM may comprise, for example, a programmable read-only memory (PROM), an erasable programmable read-only memory (EPROM), an electrically erasable programmable read-only memory (EEPROM), or other like memory device. Storage memory may be implemented using nonvolatile memory to provide long term retention of data and instructions.

The memory 1006 may refer to the combination of volatile and nonvolatile memory used to store instructions as well as data. For example, data and instructions may be stored in nonvolatile memory and loaded into volatile memory for processing by the processor(s) 1003. The execution of instructions may include, for example, a compiled program that is translated into machine code in a format that can be loaded from nonvolatile memory into volatile memory and then run by the processor 1003, source code that is converted in suitable format such as object code that is capable of being loaded into volatile memory for execution by the processor 1003, or source code that is interpreted by another executable program to generate instructions in volatile memory and executed by the processor 1003, etc. Instructions may be stored or loaded in any portion or component of the memory 1006 including, for example, RAM, ROM, system memory, storage, or any combination thereof.

While the memory 1006 is shown as being separate from other components of the multiview display system 1000, it should be appreciated that the memory 1006 may be embedded or otherwise integrated, at least partially, into one or more components. For example, the processor(s) 1003 may include onboard memory registers or cache to perform processing operations.

I/O component(s) 1009 include, for example, touch screens, speakers, microphones, buttons, switches, dials, camera, sensors, accelerometers, or other components that receive user input or generate output directed to the user. I/O component(s) 1009 may receive user input and convert it into data for storage in the memory 1006 or for processing by the processor(s) 1003. I/O component(s) 1009 may receive data outputted by the memory 1006 or processor(s) 1003 and convert them into a format that is perceived by the user (e.g., sound, tactile responses, visual information, etc.).

A specific type of I/O component 1009 is a display 1012. The display 1012 may include a multiview display (e.g., multiview display 112), a multiview display combined with a 2D display, or any other display that presents images. A capacitive touch screen layer serving as an I/O component 1009 may be layered within the display to allow a user to provide input while contemporaneously perceiving visual output. The processor(s) 1003 may generate data that is formatted as an image for presentation on the display 1012. The processor(s) 1003 may execute instructions to render the image on the display for being perceived by the user.

The bus 1015 facilitates communication of instructions and data between the processor(s) 1003, the memory 1006, the I/O component(s) 1009, the display 1012, and any other components of the multiview display system 1000. The bus 1015 may include address translators, address decoders, fabric, conductive traces, conductive wires, ports, plugs, sockets, and other connectors to allow for the communication of data and instructions.

The instructions within the memory 1006 may be embodied in various forms in a manner that implements at least a portion of the software stack. For example, the instructions may be embodied as an operating system 1031, an application(s) 1034, a device driver (e.g., a display driver 1037), firmware (e.g., display firmware 1040), or other software components. The operating system 1031 is a software platform that supports the basic functions of the multiview display system 1000, such as scheduling tasks, controlling I/O components 1009, providing access to hardware resources, managing power, and supporting applications 1034.

An application(s) 1034 executes on the operating system 1031 and may gain access to hardware resources of the multiview display system 1000 via the operating system 1031. In this respect, the execution of the application(s) 1034 is controlled, at least in part, by the operating system 1031. The application(s) 1034 may be a user-level software program that provides high-level functions, services, and other functionality to the user. In some embodiments, an application 1034 may be a dedicated ‘app’ downloadable or otherwise accessible to the user on the multiview display system 1000. The user may launch the application(s) 1034 via a user interface provided by the operating system 1031. The application(s) 1034 may be developed by developers and defined in various source code formats. The applications 1034 may be developed using a number of programming or scripting languages such as, for example, C, C++, C #, Objective C, Java®, Swift, JavaScript®, Perl, PHP, Visual Basic®, Python®, Ruby, Go, or other programming languages. The application(s) 1034 may be compiled by a compiler into object code or interpreted by an interpreter for execution by the processor(s) 1003. The application 1034 may be the application 205 of FIG. 4. The application may also be another application that provides a user interface (e.g., user interface 244) as part of configuration mode for developers who are creating the application 205 of FIG. 4.

Device drivers such as, for example, the display driver 1037, include instructions that allow the operating system 1031 to communicate with various I/O components 1009. Each I/O component 1009 may have its own device driver. Device drivers may be installed such that they are stored in storage and loaded into system memory. For example, upon installation, a display driver 1037 translates a high-level display instruction received from the operating system 1031 into lower level instructions implemented by the display 1012 to display an image.

Firmware, such as, for example, display firmware 1040, may include machine code or assembly code that allows an I/O component 1009 or display 1012 to perform low-level operations. Firmware may convert electrical signals of particular component into higher level instructions or data. For example, display firmware 1040 may control how a display 1012 activates individual pixels at a low level by adjusting voltage or current signals. Firmware may be stored in nonvolatile memory and executed directly from nonvolatile memory. For example, the display firmware 1040 may be embodied in a ROM chip coupled to the display 1012 such that the ROM chip is separate from other storage and system memory of the multiview display system 1000. The display 1012 may include processing circuitry for executing the display firmware 1040.

The operating system 1031, application(s) 1034, drivers (e.g., display driver 1037), firmware (e.g., display firmware 1040), and potentially other instruction sets may each comprise instructions that are executable by the processor(s) 1003 or other processing circuitry of the multiview display system 1000 to carry out the functionality and operations discussed above. Although the instructions described herein may be embodied in software or code executed by the processor(s) 1003 as discussed above, as an alternative, the instructions may also be embodied in dedicated hardware or a combination of software and dedicated hardware. For example, the functionality and operations carried out by the instructions discussed above may be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc.

In some embodiments, the instructions that carry out the functionality and operations discussed above may be embodied in a non-transitory, computer-readable storage medium. The computer-readable storage medium may or may not be part of the multiview display system 1000. The instructions may include, for example, statements, code, or declarations that can be fetched from the computer-readable medium and executed by processing circuitry (e.g., the processor(s) 1003). In the context discussed herein, a ‘non-transitory, computer-readable medium’ may be any medium that can contain, store, or maintain the instructions described herein for use by or in connection with an instruction execution system, such as, for example, the multiview display system 1000.

The non-transitory, computer-readable medium can comprise any one of many physical media such as, for example, magnetic, optical, or semiconductor media. More specific examples of a suitable computer-readable medium may include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

The multiview display system 1000 may perform any of the operations or implement the functionality descried above. For example, the flowchart and process flows discussed above may be performed by the multiview display system 1000 that executes instructions and processes data. While the multiview display system 1000 is shown as a single device, embodiments are not so limited. In some embodiments, the multiview display system 1000 may offload processing of instructions in a distributed manner such that a plurality of multiview display systems 1000 or other computing devices operate together to execute instructions that may be stored or loaded in a distributed arranged. For example, at least some instructions or data may be stored, loaded, or executed in a cloud-based system that operates in conjunction with the multiview display system 1000.

Thus, there have been described examples and embodiments of tilting a plane of convergence of a multiview image. For example, the plane of convergence may be tilted in a real-time graphics pipeline as the multiview image is rendered for display. In this respect, the plane of convergence may be tilted by applying a shear function to different views of the multiview image based on the relative location of each view. It should be understood that the above-described examples are merely illustrative of some of the many specific examples that represent the principles described herein. Clearly, those skilled in the art can readily devise numerous other arrangements without departing from the scope as defined by the following claims.

What is claimed is:

1. A computer-implemented method of tilting a plane of convergence of a multiview image, the method comprising:
loading a view of the multiview image into memory, the view being formatted as a bitmap defined by a pixel coordinate system;
identifying a distance between the view and a center point of view; and
rendering the view in a graphics pipeline as a sheared view according a shear function applied along an axis of the pixel coordinate system, a shear strength of the shear function correlating with the distance.

2. The method of tilting the plane of convergence of the multiview image of claim 1, wherein the shear function is configured to skew the view only along a horizontal axis of the pixel coordinate system.

3. The method of tilting the plane of convergence of the multiview image of claim 2, wherein the multiview image comprises a map generated by a navigation application.

4. The method of tilting the plane of convergence of the multiview image of claim 1, wherein the distance between the view and the center point of view is identified by determining an ordered view number of the view of the multiview image.

5. The method of tilting the plane of convergence of the multiview image of claim 1, further comprising:
receiving user input from a user interface; and
determining the shear strength based on the user input.

6. The method of tilting the plane of convergence of the multiview image of claim 1, the method further comprising:
automatically determining the shear strength by calculating a disparity value at a common point among the view and another view of the multiview image.

7. The method of tilting the plane of convergence of the multiview image of claim 1, further comprising:
receiving user input from a user interface;
determining a range of disparity values based on the user input; and
configuring a shader to operate on pixels of the view in response to the pixels having disparity values within the range of disparity values.

8. The method of tilting the plane of convergence of the multiview image of claim 7, wherein the shader is configured to perform at least one of transparency operation and a depth of field operation.

9. A multiview display system, the system comprising:
a processor; and
a memory that stores a plurality of instructions, which, when executed, cause the processor to:
load a view of a multiview image into the memory, the view being formatted as a bitmap defined by a pixel coordinate system; and
transmit to a graphics pipeline an instruction to render the view as a sheared view according a shear function applied along an axis of the pixel coordinate system, a shear strength of the shear function correlating with a position of the view relative to other views in the multiview image,
wherein the graphics pipeline is configured to implement the shear function as pixels of the bitmap are sampled by the graphics pipeline, and
wherein the multiview display system is configured to tilt a plane of convergence in the graphics pipeline.

10. The multiview display system of claim 9, wherein the shear function is configured to skew the view only along a horizontal axis of the pixel coordinate system.

11. The multiview display system of claim 9, wherein the multiview image comprises a map generated by a navigation application.

12. The multiview display system of claim 9, wherein the plurality of instructions, which, when executed, further cause the processor to:
receive user input from a user interface; and
determine the shear strength based on the user input.

13. The multiview display system of claim 9, wherein the plurality of instructions, which, when executed, further cause the processor to: automatically determine the shear strength by calculating a disparity value at a common point among the view and another view of the multiview image.

14. The multiview display system of claim 9, wherein the plurality of instructions, which, when executed, further cause the processor to:
receive user input from a user interface;
determine a range of disparity values based on the user input; and
configure a shader to operate on pixels of the view in response to the pixels having disparity values within the range of disparity values.

15. The multiview display system of claim 14, wherein the shader is configured to perform at least one of transparency operation and a depth of field operation.

16. The multiview display system of claim 9, wherein the multiview display system is configured to provide broad-angle emitted light during a 2D mode using a broad-angle backlight;
wherein the multiview display system is configured to provide directional emitted light during a multiview mode using a multiview backlight having an array of multibeam elements, the directional emitted light comprising a plurality of directional light beams provided by each multibeam element of the multibeam element array;
wherein the multiview display system is configured to time multiplex the 2D and multiview modes using a mode controller to sequentially activate the broad-angle backlight during a first sequential time interval corresponding to the 2D mode and the multiview backlight during a second sequential time interval corresponding to the multiview mode; and
wherein directions of directional light beams of the directional light beam plurality correspond to different view directions of a multiview image.

17. The multiview display system of claim 16, wherein the multiview display system is configured to guide light in a light guide as guided light; and
wherein the multiview display system is configured to scatter out a portion of the guided light as the directional emitted light using multibeam elements of the multibeam element array, each multibeam element of the multibeam element array comprising one or more of a diffraction grating, a micro-refractive element, and a micro-reflective element.

18. A non-transitory, computer-readable storage medium storing instructions that, when executed by a processor of a computing system, implement tilting a plane of convergence in a graphics pipeline comprising:
generating a plurality of views of a multiview image, each view being formatted as a bitmap defined by a pixel coordinate system, the plurality of views comprising a first view and a second view;
rendering the first view in the graphics pipeline as a first sheared view according a first sheared strength of a shear function applied along an axis of the pixel coordinate system; and
rendering the second view in the graphics pipeline as a second sheared view according a second sheared strength of the shear function applied along the axis of the pixel coordinate system.

19. The non-transitory, computer-readable storage medium of claim 18, wherein the shear function is applied only along a horizontal axis of the pixel coordinate system.

20. The non-transitory, computer-readable storage medium of claim 18, wherein the shear function is configured to skew the first view and second view along a vertical axis of the pixel coordinate system.

21. The non-transitory, computer-readable storage medium of claim 18, wherein the first shear strength is a negative shear strength and the second shear strength is a positive shear strength.

22. The non-transitory, computer-readable storage medium of claim 18, wherein the graphics pipeline is configured to implement the shear function as pixels of the bitmaps of the multiview image are sampled by the graphics pipeline.
